(19) United States
(12) Patent Application Publication
(10) Pub. No.: US 2014/0179419 A1
(43) Pub. Date: Jun. 26, 2014

(54) SYSTEM AND METHOD FOR VERIFICATION OF IDENTIFICATION AND RESIDENCE IN AN ONLINE GAMING ENVIRONMENT

(71) Applicants: Dennis Nadeau, Pompano, FL (US); Virginia Balabanova, Pompano Beach, FL (US); Greg Hanis, Pompano Beach, FL (US)

(72) Inventors: Dennis Nadeau, Pompano, FL (US); Virginia Balabanova, Pompano Beach, FL (US); Greg Hanis, Pompano Beach, FL (US)

(21) Appl. No.: 14/098,824

(22) Filed: Dec. 6, 2013

Related U.S. Application Data
(60) Provisional application No. 61/734,164, filed on Dec. 6, 2012.

(51) Int. Cl. G07F 17/32

(52) U.S. Cl. CPC G07F 17/3241
USPC 463/29

(57) ABSTRACT

A system and method is provided whereby a user registers for access to an online gaming or sweepstakes and transmits an image of a government issued identification for verification of residence.

### BACKGROUND OF THE INVENTION

The on-line gaming environment has enjoyed increased popularity throughout the last several years. Particularly on-line sweepstakes and on-line gaming such as on-line poker and like have become particularly attractive to users. A difficultly arises in awarding prizes in that most state statutes require verification of residence prior to any distribution of prizes. Typically, a user will mail a copy of their government identification to the operators of an on-line gaming site. This process takes days for mailing and further requires numerous days for processing before any prizes can be distributed. On-line operators are required by most state statutes to conduct themselves in this manner. There is a need for rapid and secure verification of identity and residence of users in an on-line gaming environment. The present invention addresses this need by providing a system and method whereby residence of users is verified in minutes instead of days.

### BRIEF DESCRIPTION OF THE DRAWING

FIG. 1 is a flow chart showing the steps of the invention and the possible outcomes

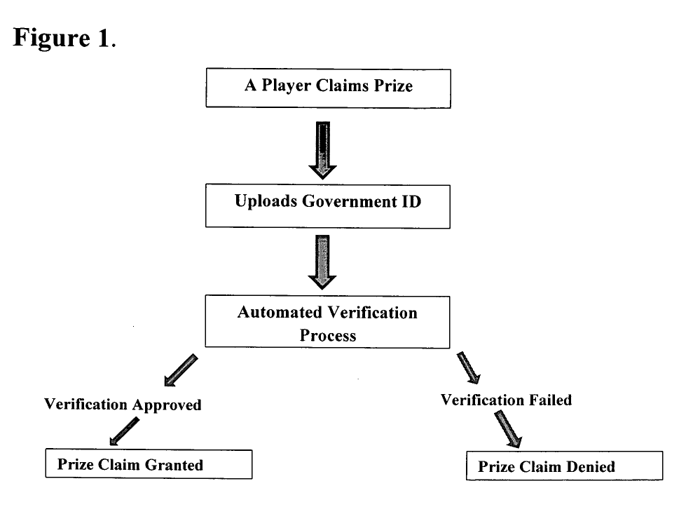

### DETAILED DESCRIPTION OF THE PREFERRED EMBODIMENT

In one embodiment, the present invention incorporates a sign up and validation procedure that occur sequentially.

In another embodiment, the validation procedure of the present is a stand-alone system and method. A user accesses a website and validation commences with the user inputting appropriate information relating to their current residence. Information would include; State, Country, and other requested identifying information to verify that user's location. In one embodiment, upon entry of resident's location information, the system and method of the present information will use the IP address used for transmission in order to provide an additional verification as to the person's physical location when making the initial validation.

In one embodiment, if the IP address does not match the physical location provided a user may be asked for additional information relating to their physical location and their resident address. A user will then be prompted to provide a government issued identification for the system. The government issued identification can be sent by any acceptable means. In a preferred embodiment, the user will use a portable computing device such as, cell phone, smartphone, tablet, PC and the like and take a photograph of their government issued identification. The user will then be instructed to send this photograph to the system for verification. The sending of this photograph can also be any acceptable electronic means including but not limited to email, SMS, MMS, and the like. The system and method of present invention will then evaluate the information provided in the photograph.

The system and method of the present invention will retrieve the data from the government identification and immediately verify the age of the application. After the age has been verified and is deemed acceptable, the system and method of the present invention will further verify the location and query the system database for specific laws and rules governing on-line participation from the user's location. If, the user is prohibited by law from participating in on-line tournament poker or on-line gaming tournament sweepstakes and the like based on their residence, the user will be so informed via text, social media or email communication.

In one embodiment, the user may have the option to continue participation having confirmed the fact that they understand they will not be eligible to win prizes awarded by the tournament or gaming website. The system and method of the present invention represents a significant improvement over current on-line gaming environments in that on-line gaming environments are significantly limited in their ability to verify resident's location. Typically, resident's location verification can take anywhere from two to seven days. The system and method of the present invention automates the verification process and, in a matter of minutes, a user is verified as to their age and location.

In one embodiment the system and method of the present invention takes the resident's information and queries the central database in order to apply applicable laws relating to distribution of prizes. The database will include laws relating to all 50 U.S. States, Commonwealths as well as applicable laws relating to the awarding of prizes outside of the Unites States.

In an embodiment where the system and method of the present invention is utilized in a country other than the United States, it is contemplated that the system database will query applicable laws relating to prize distribution originating from the operator of the online gaming site and delivery of prizes to a recipient based on verified residence location.

In one embodiment, the system and method of the present invention reads the photograph provided by the applicant and confirms the validity and genuineness of the ID. Validity is confirmed in manners known in the art such as state issued driver's license that have marked indicia on the surface that are visible to certain types of light.

In one embodiment, the applicant will be asked to provide an electronic signature verifying that the identification and information provided is correct and accurate. The electronic signature will be used for further verification in the future when a person attempts to claim a prize. The system and method of the present invention will match the provided for electronic signature with an electronic signature provided upon prize claiming processes. If the signatures do not match, an investigation will be undertaken in order to verify that the person attempting to claim a prize is the same person who signed up initially.

In a preferred embodiment, a person will utilize the system and method of the present invention in an on-line tournament or sweepstakes setting. A preferred embodiment includes a user utilizing the system and method of the present invention for an on-line poker and casino gaming environment. As a user progresses through their on-line tournament, their account is credited with winnings when the user acquires winnings. When a user decides he is finished with a particular game, the user will make a request of the on-line tournament to collect their prize, cash out their account. The on-line tournament system will receive this request and verify that the user has funds in their account relating to their requested winnings. The user will then be asked to acknowledge all the terms and conditions relating to the distribution of prizes. Once the user has acknowledged, the system will search the database for the identification and verification procedures described herein. Once the user has been verified, the user will again be asked to provide an electronic signature. The system will query the electronic signature to make sure it matches the original electronic signature provided during the verification process. Once the electronic signatures have been verified the system will inform the administrator of the on-line environment to process the requested payment.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

We claim:

1. A system and method for remote verification of a participant in an on-line sweepstakes or gaming site said system and method comprising:
a program stored on a non-transitory computer medium, said program being remotely accessible by a registrant;
accessing said program by said registrant;
providing to said program information identifying the residence of said registrant;
acquiring a computer readable image of at least one government issued identification;
transmitting said image of said government issued identification to said system;
receiving by said system said transmitted image;
evaluation of said image and determining residence location;
associating said residence information with said remote user;
storing said information relating residence of said user.

2. The system and method of claim 1 wherein said accessing said program is by Internet transmission.

3. The system and method of claim 1 wherein said evaluation of said image and determining residence location includes removing residence information from said identification and matching said residence information with user input having residence information.
